(19) United States
(12) Patent Application Publication
(10) Pub. No.: US 2003/0221173 A1
(43) Pub. Date: Nov. 27, 2003

(54) Method and apparatus for detecting connectivity conditions in a netlist database

(76) Inventor: Rory L. Fisher, Fort Collins, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/155,549

(22) Filed: May 24, 2002

(51) Int. Cl. G06F 17/50

(52) U.S. Cl. 716/5; 716/4; 716/12

(57) ABSTRACT

A method and apparatus provided for analyzing connectivity conditions in a netlist data file. The hierarchy of the netlist data file is traversed and nets and leaf cells are identified. Connections between nets and leaf cells are identified. Once the connections between nets and leaf cells have been identified, determinations are made as to whether the leaf cells are properly connected to their respective nets. Conditions such as gate-only nets, zero-connects, one-connects, drive fights, floating-nets and port-direction mismatches are identified by analyzing the connections between nets and leaf cells. Determinations may then be made as to whether a condition has been detected that should be corrected.

### TECHNICAL FIELD OF THE INVENTION

The present invention relates generally to optical devices and, more particularly, to a method and an apparatus that enable a netlist to be traversed and to detect connectivity conditions within the netlist.

### BACKGROUND OF THE INVENTION

A netlist is a syntactical description of components of an IC and the nodes to which the components are attached. A component of a netlist may be a combination of logical elements, such as, for example, a state machine having registers and gates or clusters of logic, or it may be a combination of only a few transistors, such as an AND gate, an inverter, a buffer, etc. The former combination would generally be viewed as a cell block and is at a higher level of abstraction than the latter combination, which is generally referred to as a leaf cell. A netlist is typically hierarchical in nature, with the hierarchy comprising child blocks branching off of parent blocks, with each child capable of having only one parent, but a parent capable of having more than one child. Within the blocks, transistor-level combinations, such as an AND gate, an XOR gate, an XNOR gate, etc., are referred to as the leaf cells. A parent block only references the child block and contains no information about the contents of the child block.

The netlist is often represented by the syntax of what is known as a Block Description Language (BDL). BDL is currently one of the commonly used languages used for programmatically describing a netlist, although other languages, such as Verilog, can be used to programmatically describe a netlist. Once the netlist has been created, the design is often taken to the next step, which is to create a simulation model based on the netlist code and simulate the design using a simulation tool, such as Verilog.

The simulation should allow defects in the model to be detected if they exist. However, typically, the artwork, or layout, of the IC is created from the netlist prior to, or as, simulation is being performed. Therefore, if a defect is detected during simulation, both the netlist and the layout generally must be corrected. Furthermore, simulation is often delayed until most of the layout has been completed for the IC. Of course, a defect discovered at this point in the IC design process is very expensive and time consuming to correct.

One known approach for preventing these types of problems from occurring is to use formal verification tools that compare the behavioral code of the design to the logical netlist. This approach generally works well on the entire design, except for the test logic built into the IC for testing, which typically is not included in the behavioral code. Also, connectivity errors will not be detected using formal verification tools. They also will not be detected through regression tests because regression tests typically don't perform verification of the test logic.

Accordingly, a need exists for a tool that enables defects to be detected in the netlist syntactical expression so that any defects can be detected and corrected prior to the layout being designed and simulation, thereby avoiding the costs and time delays associated with simulation delays and the need to correct both the layout and the netlist.

### SUMMARY OF THE INVENTION

The present invention provides a method and apparatus for analyzing connectivity conditions in a netlist data file. The netlist preferably is not flattened, but is in a hierarchical format. The hierarchy of the netlist data file is traversed and nets and leaf cells are identified. Then, connections between particular nets and particular leaf cells are identified. Once the connections between nets and leaf cells have been identified, determinations are made as to whether the leaf cells are properly connected to their respective nets.

Connectivity conditions such as, for example, gate-only nets, zero-connects, one-connects, drive fights, floating-nets and port-direction mismatches, can be identified by analyzing the connections between nets and leaf cells. Determinations may then be made as to whether a condition has been detected that should be corrected.

The method of the present invention for detecting connectivity conditions in a netlist preferably comprises the steps of generating a list of leaf cells comprised in the netlist data file, generating a list of nets comprised in the netlist data file, determining which of the leaf cells are connected to which of the nets, and analyzing connections between nets and leaf cells to determine whether any connection conditions exist in the netlist data file that may result in a connection defect that needs to be corrected.

The apparatus of the present invention preferably is a computer that executes a software tool of the present invention to cause the netlist data file to be read out of memory and analyzed for connectivity conditions that may result in a defect that needs to be corrected.

These and other features and advantages of the present invention will become apparent from the following description, drawings and claims.

### BRIEF DESCRIPTION OF THE DRAWINGS

FIG. 1 is a block diagram illustrating the apparatus and system of the present invention for determining connectivity conditions in an IC design netlist.

FIG. 2 is a block diagram illustrating the hierarchical nature of the netlist that the present invention of FIG. 1 traverses to determine connectivity conditions.

FIG. 3 is a flow chart illustrating the method of the present invention performed in accordance with the preferred embodiment by the apparatus and system shown in FIG. 1.

### DETAILED DESCRIPTION OF THE PREFERRED EMBODIMENT

In accordance with the present invention, it has been determined that the tools used to create the netlist allow certain conditions to exist in the design that the designer may not have intended and that may result in design defects. These conditions include: (1) zero-connects, which are unconnected block ports; (2) one-connects, which are ports of the leaf cells in the design that do not connect to other leaf cells in the design; (3) gate-only nets, which are unconnected inputs to logic; (4) floating net, which is when a given net connects to zero leaf cells; (5) port direction mismatchs, which is when a given net is ported and the direction of that port is different from the direction of the leaf-cell(s) to which it is connected; and (6) drive fights, which, in this context, correspond to a net driven by two or more cells of different type (e.g., the output of an OR gate and the output of an AND gate driving the same net). These conditions may result in defects in the netlist even though the designer may believe that the netlist is correct.

In accordance with the present invention, a tool is provided that traverses the netlist file prior to a simulation model and design layout, or artwork, being created, and identifies defects that need to be corrected. This allows corrective measures to be taken early on in the design process so that only the netlist needs to be corrected (as opposed to the simulation model and/or the design layout). Furthermore, the tool of the present invention may be used on individual blocks of an IC design, and therefore it is not necessary to wait until the netlist defining the entire IC has been assembled before corrective measures may be taken, if they are necessary. Also, the present invention enables defects in the test logic of the IC design to be detected and corrected, which formerly were not detectable using verification tools.

Because BDL is a commonly used language for describing netlists, in the interest of brevity and for example purposes, the present invention will be described with reference to BDL. However, other languages, such as, for example, Verilog, may also be used to describe a netlist file. For example, a customer may use a language such as Registered Transfer Logic (RTL) to describe the behavior of what the customer wants a state machine to do, rather than actually defining the logic elements. The present invention is not limited with respect to the tool that is used to describe the netlist file, as will be understood by those skilled in the art in view of the disclosure provided herein.

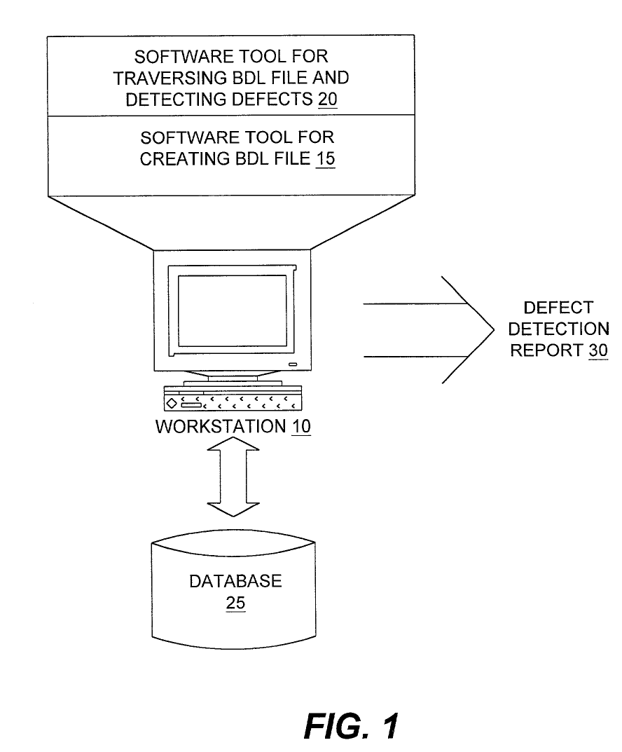

FIG. 1 is a block diagram of the apparatus of the present invention in accordance with the preferred embodiment. The apparatus comprises a computer 10 of any type suitable for performing the operations discussed herein. A designer (not shown) uses a software tool 15 being executed by the computer 10 to create a BDL file. The BDL file is stored in a database 25 that is in communication with the computer 10. Once the BDL file has been created, the computer 10 executes the defect detection software tool 20 of the present invention. The defect detection software tool 20 of the present invention causes the BDL file to be read out of database 25.

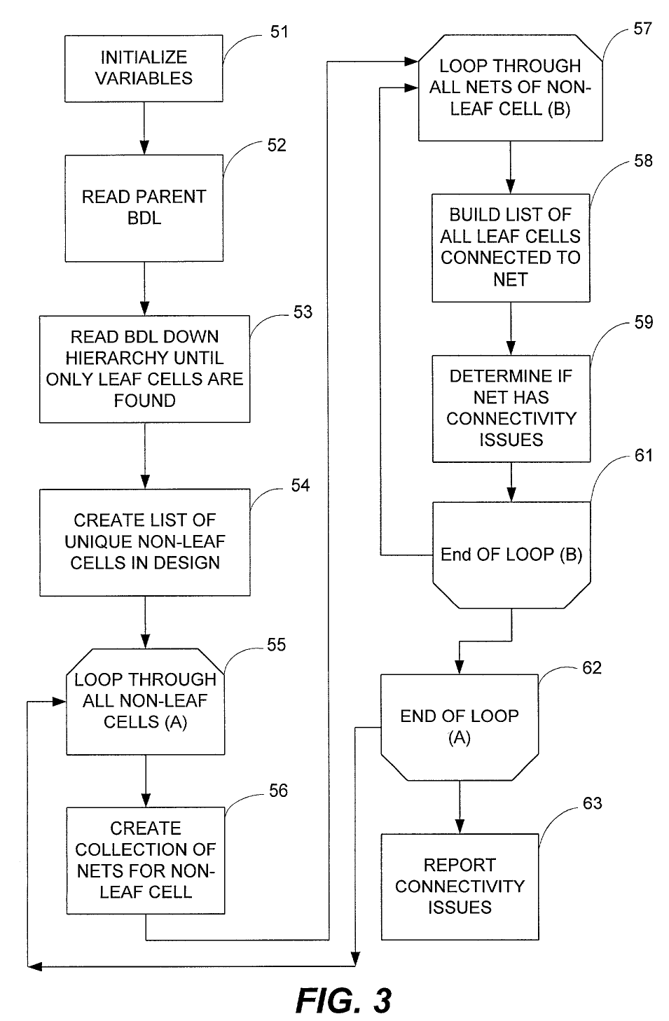

During execution, the defect detection algorithm 20 reads the hierarchical BDL netlist file from the database 25 beginning with the top level parent BDL block and then non-redundantly traverses down through the BDL blocks to the leaf-cell level. The connections of the leaf cells are then analyzed to determine whether there are any connectivity issues. The manner in which this is accomplished will be described below with reference to FIG. 3.

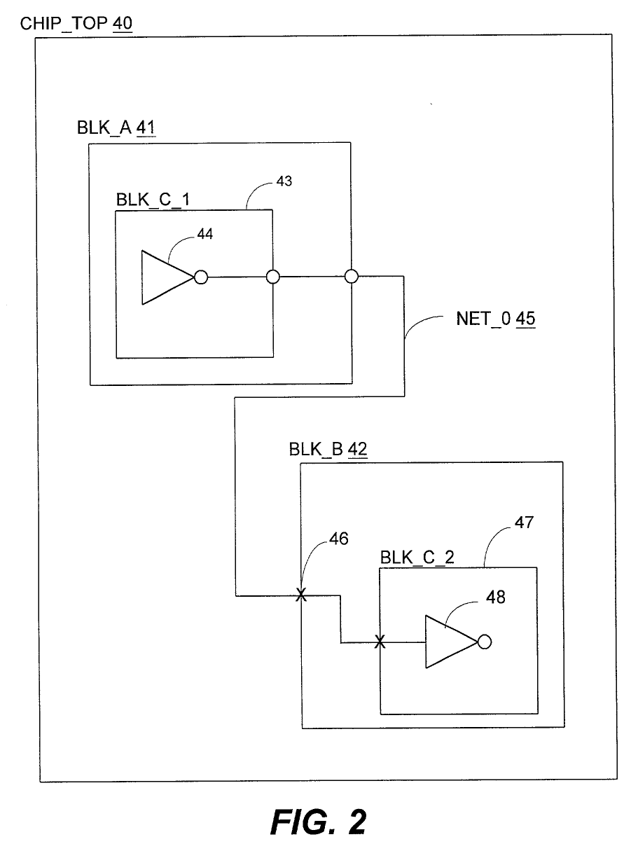

The hierarchical nature of the netlist can be seen from the example shown in FIG. 2. A parent block may contain, for example, five state machines. Each of these state machines would be viewed as a child block of the parent block. Therefore, a block could be made up of several blocks. Wiring will exist between the state machines, and at a higher level up in the hierarchy, another block may instantiate, as a child block, the block containing the state machines. The top level block in FIG. 2, “CHIP_TOP” 40, is the highest level block in the hierarchy. Within “CHIP_TOP” 40 are child blocks “BLK_A” 41 and “BLK_B” 42. Within child block 41 is a leaf cell block “BLK_C_1” 43, which comprises an inverter 44. The output of leaf cell 43 is connected by “NET_0” 45 to the input 46 of “BLK_B” 42, which is connected to the input of inverter 47 of leaf cell 48, which is comprised by “BLK_B” 42. In this example, “NET_0” 45 is the low level net and it connects the output of inverter 44 to the input of inverter 48. Each component in the netlist file is identified by a unique identifier.

During execution, the defect detection software tool 20 of the present invention traverses the hierarchy of the BDL file and detects and identifies any connectivity defects. The defect detection software tool 20 then causes a defect detection report 30 to be generated, which generally is a connectivity report that reports connectivity issues to the designer to enable the designer to correct any connectivity problems. The manner in which these tasks are accomplished will now be described with reference to the flow chart of FIG. 3.

The defect detection software tool 20 first performs variable initialization and then reads the top level block of the BDL file from memory, as indicated by blocks 51 and 52, respectively. The top level BDL file would correspond to “CHIP_TOP” 40 in FIG. 2. The tool 20 then reads the BDL file down the hierarchy until only leaf cells are found, as indicated by block 53. As the tool 20 reads down the hierarchy, it makes a list of non-leaf cell blocks in the design, which may be, for example, state machines, as indicated by block 54. The tool 20 then loops through all of the listed non-leaf cell blocks and makes a list of nets for each of the non-leaf cell blocks, as indicated by blocks 55 and 56, respectively. Blocks “BLK_A” 41 and “BLK_B” 42 in FIG. 2 are non-leaf cells because they contain leaf cells “BLK_C_1” 43 and “BLK_C_2” 47.

Once all of the nets have been collected for each of the non-leaf cells, the tool 20 loops through all nets associated with each non-leaf cells and builds a list of all leaf cells connected to each net, as indicated by blocks 57 and 58, respectively. For each leaf cell connected to a net, a determination is made as to whether or not any of the aforementioned connectivity issues exist, as indicated by block 59. The manner in which connectivity issues can be determined will be described below in more detail. However, those skilled in the art of IC design will understand, in view of the discussion provided herein, the manner in which such connectivity issues could be determined in accordance with the present invention.

The “END OF LOOP” block 61 indicates that this is an iterative process that is performed for all nets connected to leaf cells. In order to prevent wasting time and duplicating efforts, the software tool 20 will ignore nets that are ported because those nets have already been covered at the next higher level in the hierarchy. In other words, if a wire, i.e., net, exists inside of “BLK_B” 42 in FIG. 2 that is either connected to an input or an output of that block, then at the next level higher in the hierarchy, which corresponds to “BLK_A” 41 in this example, that net has already been examined for connectivity issues. The tool 20 of the present invention will make a note of this to enable it to know that it has already examined that net.

Once the loop corresponding to blocks 57, 58, 59 and 61 has been completed, the process moves to block 62, which corresponds to the next higher level in the hierarchy. If all non-leaf cells have been looped through, the tool 20 causes a connectivity report to be issued, as indicated by block 63. If all non-leaf cells have not been looped through, then the process returns to block 55, and the tasks performed At blocks 56, 57, 58, 59 and 61 are reiterated.

Generally, the tool 20 of the present invention creates a connectivity database by traversing through the netlist file (e.g., the BDL file) and then examines it to determine whether any connectivity issues exist. The tool 20 determines the number of leaf cell inputs and leaf cell outputs connected to a given net, and from that, determines whether certain defects exist in the netlist file. The following connectivity conditions are examples of the types of conditions that are detected by the tool 20 of the present invention: (1) zero-connect port: a port of a given block connects to no leaf cells; (2) one-connect: a given net connects to exactly one leaf cell and is not ported at the top-level block; (3) gate-only net: a given net connects to one or more leaf-cell inputs and no leaf-cell outputs and is not ported at the top-level block; (4) potential drive-fight: two or more leaf-cells have their output ports connected to a given net and the same two or more cells are not fully-connected in parallel; (5) floating net: a given net connects to zero leaf cells; and (6) port direction mismatch: a given net is ported and the direction of that port is different from the direction of the leaf-cell(s) to which it is connected.

All such defects can easily be connected by using the tool 20 of the present invention to examine net connectivity down the hierarchy. The software tool 20 of the present invention that reads the netlist data file and detects connectivity conditions, can be written in a variety of languages, such as, for example, Perl, Ruby and C++.

It should be noted that the present invention preferably operates on a netlist database that is hierarchical, or in other words, which has not been flattened. The present invention could also work with a flattened netlist database, although doing so may require more memory. Those skilled in the art will understand the manner in which the present invention could be applied in this case.

It should be noted that the present invention has been described with reference to example and preferred embodiments. However, those skilled in the art will understand that modifications can be made to the embodiments discussed herein that are within the scope of the present invention. For example, although the software tool 20 of the present invention is shown as being executed on the same computer that generates the netlist file, this is not a requirement of the present invention but is merely for ease of illustration. It should also be noted that the database 25 does not need to be directly connected to computer 10, but may be in communication with computer 10 via any type of network. Also, although the present invention preferably is a software tool that is executed by a computer, the functions performed by the present invention could also be performed solely in hardware or by a combination of hardware and software.

What is claimed is:

1. An apparatus for detecting connectivity conditions in a netlist, the netlist being a data file, the apparatus comprising:
first logic, the first logic analyzing the netlist data file and generating a list of all leaf cells and a nets to which any of said leaf cells are connected, each leaf cell having an identifier associated therewith and each net having an identifier associated therewith; and
second logic, the second logic analyzing connections between any of said nets and any of said leaf cells and determining whether and connection conditions exist in the netlist data file that may result in a connection defect that needs to be corrected.

2. The apparatus of claim 1, wherein said first and second logic correspond to software being executed by a computer.

3. The apparatus of claim 1, wherein the netlist data file is a block description language (BDL) data file.

4. The apparatus of claim 1, wherein the netlist data file is a Verilog language data file.

5. The apparatus of claim 1, further comprising a database, the netlist data file being stored in the database in a hierarchical format, the first logic reading the netlist data file from the database beginning at a top of the hierarchical netlist data file and traversing down the hierarchy until only leaf cells and the connections of the leaf cells to a net are found.

6. The apparatus of claim 1, wherein the connectivity conditions determined by the second logic include gate-only nets, zero-connects, one-connects, drive fights, floating-nets and port-direction mismatches.

7. A method for detecting connectivity conditions in a netlist, the netlist being a data file, the method comprising the steps of:
generating a list of leaf cells comprised in the netlist data file;
generating a list of nets comprised in the netlist data file;
determining which of the leaf cells are connected to which of the nets, each leaf cell having an identifier associated therewith and each net having an identifier associated therewith; and
analyzing connections between nets and leaf cells to determine whether any connection conditions exist in the netlist data file that may result in a connection defect that needs to be corrected.

8. The method of claim 7, wherein the method is performed by a computer.

9. The method of claim 7, wherein the netlist data file is a block description language (BDL) data file.

10. The method of claim 7, wherein the netlist data file is a Verilog language data file.

11. The method of claim 7, wherein the netlist data file is stored in the database in a hierarchical format, the data file being read from the database beginning at a top of the hierarchical netlist data file and traversing down the hierarchy until only leaf cells and the connections of the leaf cells to a net are found.

12. The method of claim 7, wherein the connectivity conditions include gate-only nets, zero-connects, one-connects, drive fights, floating-nets and port-direction mismatches.

13. A computer program for detecting connectivity conditions in a netlist, the netlist being a data file, the computer program being embodied on a computer readable medium, the program comprising:
a first code segment, the first code segment generating a list of leaf cells comprised in the netlist data file;
a second code segment, the second code segment generating a list of nets comprised in the netlist data file;
a third code segment, the third code segment determining which of the leaf cells are connected to which of the nets, each leaf cell having an identifier associated therewith and each net having an identifier associated therewith; and
a fourth code segment, the fourth code segment analyzing connections between nets and leaf cells to determine whether any connection conditions exist in the netlist data file that may result in a connection defect that needs to be corrected.

14. The program of claim 13, wherein the netlist data file is a block description language (BDL) data file.

15. The program of claim 13, wherein the netlist data file is a Verilog language data file.

16. The program of claim 13, wherein the netlist data file is stored in a database in a hierarchical format, and wherein the program reads the netlist data file from the database beginning at a top of the hierarchical netlist data file and traversing down the hierarchy until only leaf cells and the connections of the leaf cells to a net are found and then determines which leaf cells are connected to which nets and whether any connectivity conditions exist that may result in a defect that needs to be corrected.

17. The program of claim 13, wherein the connectivity conditions determined by the second logic include gate-only nets, zero-connects, one-connects, drive fights, floating-nets and port-direction mismatches.
